(19) United States
(12) Patent Application Publication
(10) Pub. No.: US 2004/0113491 A1
(43) Pub. Date: Jun. 17, 2004

(54) Actuation device for actuating a lock

(76) Inventors: Helmut Mauser, Herzogenrath (DE); Bernhard Reul, Herzogenrath (DE); Alwin Timmermann, Koeln (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/467,340

(22) PCT Filed: Feb. 20, 2002
(86) PCT No.: PCT/FR02/00635

(30) Foreign Application Priority Data
Feb. 24, 2001 (DE) 101 09 128.1

(51) Int. Cl. B60R 25/00

(52) U.S. Cl. 307/10.2

(57) ABSTRACT

Actuating device for a lock mechanism (13) comprising a device (5, 6) for transmitting and receiving signals which can be transmitted without contact, at least one switching device (9) for connecting the interrogation dialog and an actuation device (11) associated with the transmission and reception device and found in the closed or locked position. The transmission and reception device comprises a control element (5) and another element (6) arranged in close proximity, the actuating device comprising at least one other switching device (4, 4′) which is associated with the control element (5) for connecting the latter so that it communicates only when it is in its actuated state.

The invention relates to an actuation device for a lock mechanism.

In certain known series of motor car (for example the BMW X5), the window glass of the tail end, arranged overall in a pivoting tailgate (hereinafter known as the rear window glass) can be opened from the outside independently of the tailgate. A lock mechanism is provided that can be activated electrically by the user of the vehicle by means of a switch so as to release the rear window glass (see also DE-A1-198 28 289). The switch is on a rear window screen wiper fixed in the rear window glass. The operation of switching (closing) said switch needs to be transmitted to a device that actuates the lock mechanism. In the vehicles described, conducting wires to which the switch is connected and through which the current controlling the actuating device can flow when the switch is in the closed state are therefore printed and baked onto the rear window glass. It is obvious that operation of the switch can activate release of the lock mechanism only if defined vehicle operating conditions are satisfied, for example the door lock mechanisms are unlocked, if the ignition is on, or such like, so as to prevent abusive use of the lock mechanism by unauthorized persons. However, the search is on to discover another solution for transmitting the operation for switching the switch.

DE-A1-198 32 516 discloses a lock for a closure installation in which a lock mechanism actuating member is controlled electrically by activation of an electronic interrogation device followed by interrogation of the authority to close of a (passive) transponder powered externally and held close to the interrogation device. A switch which has to be actuated mechanically by the user of the lock is used to activate the electronic interrogation device.

DE-A1-199 37 915 and GB-A-2 329 668 disclose other electrically operated lock mechanisms which can be actuated by portable transponders, these each time being rendered functional only after deliberate actuation of switching members by their users. This is supposed to prevent inadvertent actuation, and unauthorized recording of a signal radiated by the transponder.

FR-A1-2 783 960 discloses an electrical actuating device for the lock mechanism of the window glass of a shop window. This window glass can be opened using a portable transponder powered from the outside. The actuating device comprises a proximity detector which detects the approach of the transponder combined with a permanent magnet. The proximity detector makes it possible directly to transmit an interrogation signal using a transmission and reception antenna. The transponder responds to this interrogation signal in the form of a signal that is modulated according to a defined code, and which for its part is received by the antenna and processed. If the code corresponds to the lock, the locking action is eliminated and the window glass can be opened.

EP-0 218 251 B1 describes a (door) lock mechanism slaved to a transponder for a motor vehicle, the dialog between the interrogation device situated on the vehicle and the transponder powered by a battery being able to be triggered by mechanical actuation of a switch provided on the vehicle, for example a door handle.

DE-C1-44 34 240 describes a dynamic modulation device (transponder) endowed with an electronic switch. The latter needs to keep the service voltage of the transponder, which is radiated by induction, in a predetermined working range. This device is preferably used on miniaturized transponders (for example implantable/injectable transponders used for measurement purposes). The switch or its internal resistance exerts a considerable influence on the operational reliability of the transponder so equipped.

DE-A1-196 15 321 discloses a safety device for a vehicle, in which combinations of transponders and of transmission and reception units make it possible to detect the presence within the vehicle of a removable passenger seat and its state of occupation. It is supposed to prevent the setting-off of a restraint system (airbag) associated with the seat when this seat is removed or unoccupied.

The purpose of the invention is to propose an actuating device for a lock mechanism comprising a device for transmitting and receiving signals which are intended to be transmitted without contact and which constitute a communication (one-way communication or dialog), the transmission and reception device comprising at least one control element which is intended to communicate the actuating command for the lock mechanism. A moving window glass which can be immobilized in its closed position by means of a lock mechanism slaved to a control element will also be proposed.

According to the invention, the actuating device for a lock mechanism of an object which can be immobilized in a closed position by the lock mechanism and which can be moved when it is in the released state, particularly a window glass or door, comprising:

a device for transmitting and receiving signals capable of being transmitted without contact and constituting a communication, said device comprising at least first and second transmission and/or reception elements arranged separately from one another, the first element or control element being intended to communicate the actuation command with a view to releasing the lock mechanism,

an actuating member which can be slaved at least indirectly to the transmission and reception device according to the communication carried out between said elements so as to bring the lock mechanism into a release position,

at least one switching device for connecting said communication,

at least one other switching device associated with said control element and which connects said control element in such a way that it is not able to make said communication unless the other switching device is in the activated state, said control element being arranged beside the switching device associated with it, at least indirectly on, against or in the object which can be immobilized and, in its closed position, in close proximity to the second element of the transmission and reception device.

Still according to the invention, moving window glass, particularly a vehicle window glass, is provided with a lock mechanism and with a switch itself arranged at least indirectly on the window glass and able to be moved with it, for placing the lock mechanism in a release position which allows the window glass to be opened, a control element switchable without external power supply wires being secured to the window glass and, in its activated state, transmitting a signal to a transmitter/receiver arranged in a fixed position with respect to the closed window glass.

The characteristics of the dependent claims which follow each of the independent claims give advantageous developments of these objects.

The control element may be a passive transponder which may only respond in a “demand-response” interrogation dialog initiated from an active transponder. In that case, the communication is a dialog.

The control element may alternatively constitute a locally powered signal transmitter, the signals being received by a passive transponder. In this case, the communication is a one-way communication.

An actuating device of the type indicated at the start and in which, in addition to the interrogation dialog proper or the transmission of the signals that make up the communication, the ability either of a passive transponder to respond or a transmitter to transmit can be controlled separately by a switching device is then created overall. This has the advantage that the control element can be installed stationary in close proximity to the transmitter/receiver that corresponds to it. Even if, in the case of the passive transponder by way of control element, the interrogation dialog proper has already been activated, there is still another switching operation needed in order to transmit the response from the passive transponder which then controls the actuation of the lock mechanism.

The same is true of a transmitter by way of control element: even if the receiver associated with it and able to bring about unlocking had already been connected by a first switching device (so as to be able to receive or to transform a received signal), there would still be another switching operation associated with the transmitter needed in order for the latter to transmit the command signal, this being the condition necessary for actuating the lock mechanism.

In real life, the two switching devices are connected in series or are combined using a logic AND. It is obvious that, for this type of use, only passive transponders whose resonance or ability to transmit a response signal is influenced entirely randomly by a switching device will be suitable. It would, for example, be possible to use transponders working by induction in which the current flowing through the reception coil can be interrupted using an appropriate switch.

As for the transmitters, these need to be powered locally from a small battery or cell so that they can transmit their signals. The local power supply needed for such small transmission powers could also be provided indirectly, such as inductively. For example, inductive coupling coils can be arranged beside the receiver (primary coil) and beside the transmitter (secondary coil) associated with it.

In a preferred usage scenario, the passive transponder powered from the outside or alternatively the transmitter is arranged, in addition to the switching device associated with it, on a moving object which can be immobilized in a closed position by means of the lock mechanism, particularly on the window glass of a window. The problem of installing wires on the moving object is thus to a large extent restricted to a conducting link between the passive transponder or the emitter and the switching device which, depending on the mounting conditions, may, however, be arranged in close proximity to one another or may be produced in the form of a module. Particularly in the case of entirely glass doors or moving window glasses, the problem of hiding the supply wires from sight is solved in an elegant way with the actuating device according to the invention. All the “active” parts as far as the switching device associated with the passive transponder or with the transmitter are, together with the necessary electric wires, arranged fixedly in the region of the chassis surrounding the opening that is to be closed.

One additional advantage also lies in the fact that such an arrangement is largely insensitive to the action of inclement weather (moisture, soiling) and to the disturbances they cause (short circuits). The passive transponder or the transmitter and the switching device associated with it may fundamentally be actuated from both sides of an object that it is to be locked, for example of the window glass of a window. If need be, two switching devices will be provided, one on each side of a window glass, and which could communicate independently of one another (in parallel with one another) with the same passive transponder or the same transmitter or may alternatively switch the latter so that it enters into communication (dialog or transmission). These two switching devices may then also be constructed differently, for example one switching device may consist of electromechanical means and another switching device may be of the contactless variety. In general, it would even be possible in this way to establish different authorizations for accessing “from the outside” and “from the inside”.

The switching device associated with the active transponder used to activate dialog with the passive transponder (demand for the communication), may also be considered as being a safety switch, this may be a mechanical device (key contact, such as the ignition switch in a vehicle, the switch for unlocking a central locking mechanism).

Likewise, the switching device associated with the passive transponder or with the transmitter could thus be activated in a way known per se with or without contact by the approach of an object, for example a magnet or transmitter. Such an object may, for example, be built into a (vehicle) key, or may, for example, be carried or worn by a user on a bracelet or the like. This last instance could, for example, find applications in sanitary areas (public swimming baths), where entirely glass doors separate different zones or close lockers. As a preference, a coded signal will be needed here by way of triggering stimulus.

It is obvious that applications other than the separate locking, described at the beginning, of the windows of a vehicle are imagined, particularly also uses in the field of construction, for example for locking doors which are made entirely of glass.

In principle, the two switching devices may also be arranged in such a way as to be able to be activated simultaneously by an authorized user, and to increase the protection against abusive use, at least one of the two switches which can be actuated only indirectly (capacitive/inductive proximity switch) by a code (smart card) or key.

It may be particularly advantageous for the communication (dialog, transmission or ability to receive) to be active only for a limited length of time (a few seconds). A clock member may be provided for this. This minimizes the probability of abusive use, for example on a vehicle equipped with the actuating device and stopped at a traffic light, and also in the event of violent actuation of the switch concerned.

Other details and advantages of the subject of the invention will emerge from the drawing of an exemplary embodiment and from its description given hereinbelow.

In the drawing, and in a simplified depiction:

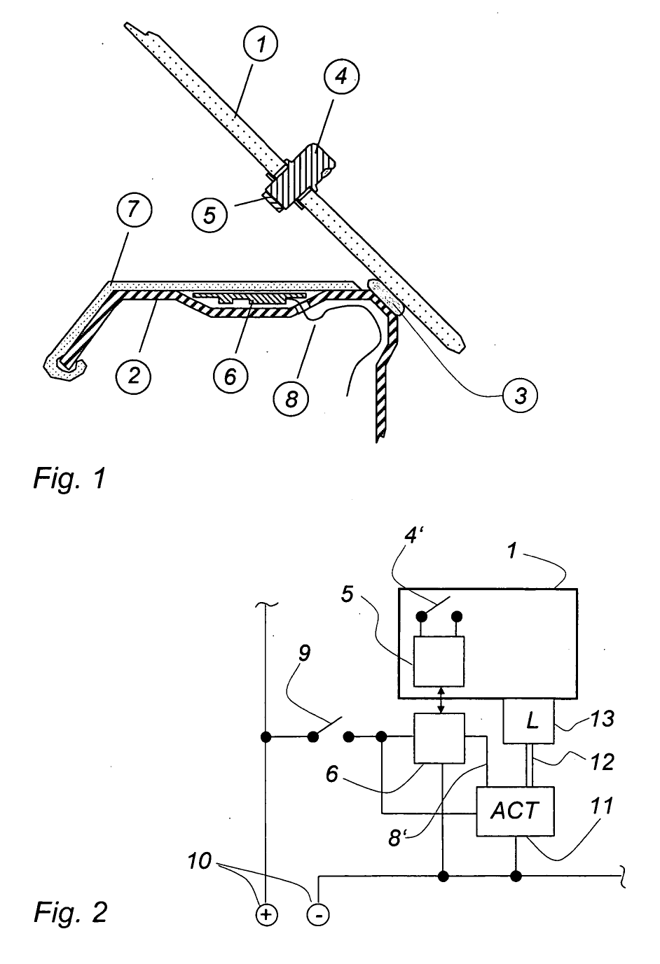

FIG. 1 is a view in cross section of the arrangement of a transmission and reception device on a moving window glass, and

FIG. 2 is a sketch of the connections and outline operation of the entire arrangement of an actuating device according to the invention.

In FIG. 1, a moving window glass 1 is placed, with the interposition of a seal 3, on the edge of a window opening which is indicated only in the form of part of a surround 2. In a way which has not been indicated in any greater detail, it is held in its closed position by a mechanical lock mechanism. The type of construction and the operation of the lock mechanism are well enough known from the state of the art that they will not be discussed in any more detail here.

A switch assembly 4 is inserted into a bore in the window glass 1. This switch is equipped with a control element 5 for controlling the transmission and reception device that we shall describe later on. The control element 5 is on the side of the window glass 1 which faces toward the surround 2. Obviously, the switch assembly may be inserted in an entirely sealed manner into the bore. In another embodiment, it could just as easily be placed on a surface of the window glass without passing through this glass. Unlike that which has been depicted, the control element could be inserted into a composite window glass such that it is inaccessible from the outside. The associated switch assembly could then, as has been depicted, be actuated mechanically from the outside, and only one of the sheets of the composite glass would need to have a bore. In an alternative form, the switch assembly could just as easily be inserted into the composite such that it is inaccessible from the outside, but it would then need to be able to be switched contactlessly, for example as a proximity switch. That would have the advantage of not needing to have an external bore in the glass.

The transmission and reception device comprises a first element which is the control element 5, and a second element 6 functionally collaborating with the element 5. The element 6 is mounted on the surround 2 and is covered by an internal trim 7. This second element is also electrically connected by a multiple conductor 8 just part of which is depicted. When the window glass is in the closed position, the two elements 5 and 6 are at any rate arranged in proximity such that the signal can be transmitted reliably between them at all times.

In a first embodiment, the control element 5 is a passive transponder and the second element 6 consists of a transmitter and of a receiver. The communication established between the two elements is a dialog, the transmitter of the element 6 being intended to send a demand signal to the passive transponder 5 which may be able to send back a response signal to the receiver of the second element 6.

In a second embodiment, the control element 5 is a simple transmitter, while the second element 6 is a receiver. The communication established between the two elements is a one-way communication. The transmitter 5 is able to transmit a signal that the receiver of the second element 6 receives.

FIG. 2 explains the method of operation of the device depicted physically in FIG. 1, the switching symbols which correspond functionally to the elements depicted in FIG. 1 being given the same numerical references.

The control element 5 is functionally connected to a switch 4′ of the switch assembly 4 depicted in FIG. 1, in such a way that it can communicate correctly with the second element only if the switch 4′ has been actuated or closed. The latter is preferably configured as a feeler which is closed only after deliberate actuation. It may be produced in the form of a hand-operated pushbutton switch but also as a proximity switch (Reed switch or the like).

The second element 6 is connected to a voltage supply 10 by a switch 9. In the context described here, the switch 9 is intended to prevent unauthorized use of the actuating device. Its structure is therefore fundamentally arbitrary. It may, for example, be a switch which is closed when a motor vehicle is running (ignition switch or the like). It may just as easily be a proximity switch, just as in the state of the art described, or an electronic switch. Clock members might also be provided, which would keep the switch 9 closed only for a predetermined length of time after actuation by a user.

Via a control wire 8′, which forms part of the multiple conductor 8 depicted in FIG. 1, the second element 6 is connected to an electromagnetic actuating member 11 which, for its part, also via the switch 9, is connected to the voltage supply 10. The actuating member 11, also denoted ACT, is connected by a mechanical actuating link 12 to a lock mechanism 13 which is also denoted by L. Here, the latter keeps the window glass 1 in its closed position. The actuating member 11 proper and the lock mechanism 13 proper have been described in many ways in the state of the art. They may, in particular, be integrated compactly into a module, unlike the schematic depiction.

In a quest for simplification, amplifiers or the like are not depicted more here but may be provided, in particular, to amplify the signal of the second element 6 which needs to be conveyed to the actuating member 11.

According to the first embodiment of the transmission and reception device, the actuating device operates as follows. As long as the switch 9 is closed, the transmitter of the second element 6 constantly and/or repeatedly at short time intervals, sends out a coded signal (that is to say the “demand” part of the dialog) to the passive transponder 5. The dialog (depicted by a double headed arrow) can be completed by a response from the passive transponder 5 only if, at the same time as the demand signal of the second element 6 is being received, the switch 4′ connected to the passive transponder 5 is also closed.

If the dialog takes place correctly, the passive transponder initiates the actuation command by transmitting a response signal to the receiver of the second element 6 which in turn transmits a corresponding switching signal which directly or indirectly activates the actuating member 11. The latter at least transiently brings the lock mechanism 13 into its release position via the actuating link 12, so that the moving window glass can be opened or opens by itself under the action of a spring.

According to the second embodiment of the transmission and reception device, the actuating device operates as follows. The switch 9 is closed so that the receiver of the second element 6 is able to receive or to transform any signal. A signal can be sent to the receiver 6 by the transmitter 5 only if the switch 4′ connected to the transmitter 5 is also closed. When the switch 4′ switches into the closed state, the transmitter 5 sends a signal that the receiver of the second element 6 receives and which in response, converting the signal it has just received, transmits a switching signal directly or indirectly activating the actuating member 11, the latter releasing the lock mechanism via the actuating link 12.

1. An actuating device for a lock mechanism (13) of an object which can be immobilized in a closed position by the lock mechanism and which can be moved when it is in the released state, particularly a window glass (1) or door, comprising:
a device for transmitting and receiving signals capable of being transmitted without contact and constituting a communication, said device comprising at least first and second transmission and/or reception elements (5, 6) arranged separately from one another, the first element or control element (5) being intended to communicate the actuation command with a view to releasing the lock mechanism,
an actuating member (11) which can be slaved at least indirectly to the transmission and reception device according to the communication carried out between said elements (5, 6) so as to bring the lock mechanism into a release position,
at least one switching device (9) for connecting said communication,
at least one other switching device (4, 4′) associated with said control element (5) and which connects said control element (5) in such a way that it is not able to make said communication unless the other switching device is in the activated state, said control element (5) being arranged beside the switching device (4, 4′) associated with it, at least indirectly on, against or in the object which can be immobilized and, in its closed position, in close proximity to the second element (6) of the transmission and reception device.

2. The actuating device as claimed in claim 1, characterized in that the control element (5) is a passive transponder with no external power supply which can be connected by means of said switching device (4, 4′) so as to be able to respond to an interrogation dialog transmitted from the second element (6) of the transmission and reception device connected by the switching device (9).

3. The actuating device as claimed in claim 1, characterized in that the control element is a transmitter with a local power supply which may be connected using said switching device (4, 4′) to transmit a signal to the second element (6) of the transmission and reception device which is able to receive or to transform this signal by connecting it via the switching device (9).

4. The actuating device as claimed in any of the preceding claims, characterized in that, provided on the two sides of the object capable of being moved is a switching device associated with the control element (5), the switching devices being functionally connected to one another in parallel.

5. The actuating device as claimed in any of the preceding claims, characterized in that the lock mechanism (13) is associated with a vehicle tailgate glass which needs to be opened from the outside independently of a bodywork hatch.

6. The actuating device as claimed in one of the preceding claims, characterized in that at least one switching device (4′) associated with the control element (5) is a switch able to be actuated by mechanical means, and in particular, a microswitch.

7. The actuating device as claimed in one of claims 1 to 5, characterized in that at least one switching device (4′) associated with the control element (5) is a contactless switching element, particularly a switching element that operates by capacitance.

8. The actuating device as claimed in one of the preceding claims, characterized in that the lock mechanism (13) is arranged in a vehicle and the switching device (9) associated with the second element (6) of the transmission and reception device is a switching device present in the vehicle, particularly an ignition switch and/or a central locking mechanism.

9. The actuating device as claimed in any of the preceding claims, characterized in that the switching devices (4′, 9) can be activated to initiate the contactless communication upon the approaching of an object.

10. The actuating device as claimed in one of claims 1 to 9, characterized in that the switching devices (4′, 9) can be activated to initiate the contactless interrogation dialog, by the approaching of an object.

11. A moving window glass, particularly a vehicle window glass, provided with a lock mechanism (13) and with a switch (4′) itself arranged at least indirectly on the window glass and able to be moved with it, for placing the lock mechanism in a release position which allows the window glass to be opened, a control element (5) of a switchable transmission and reception device without external power supply wires being secured to the window glass and, in its activated state, transmitting a command signal to a second element (6) of the transmission and reception device arranged in a fixed position with respect to the closed window glass.

12. The window glass as claimed in claim 11, characterized in that the switch (4′) is provided on a screen wiper fixed to the window glass.

13. The window glass as claimed in claim 11 or 12, characterized in that the control element (5) is arranged inside a window glass produced as a composite or laminated window glass.
